(19) United States
(12) Patent Application Publication
(10) Pub. No.: US 2010/0284862 A1
(43) Pub. Date: Nov. 11, 2010

(54) CLEANING EQUIPMENT AND ANALYZER

(75) Inventors: Kenichi Kakizaki, Shizuoka (JP); Shinichi Inamura, Shizuoka (JP); Satoshi Nemoto, Shizuoka (JP)

Correspondence Address: Townsend and Townsend and Crew LLP, Two Embarcadero Center, 8th Floor, San Francisco, CA, 94111, US

(73) Assignee: Beckman Coulter, Inc., Brea, CA (US)

(21) Appl. No.: 12/840,075

(22) Filed: Jul. 20, 2010

Related U.S. Application Data
(63) Continuation of application No. PCT/JP2009/050774, filed on Jan. 20, 2009.

(30) Foreign Application Priority Data
Jan. 21, 2008 (JP) 2008-010854

(51) Int. Cl. A47L 7/00; G01N 21/00

(52) U.S. Cl. 422/82.05; 15/320

(57) ABSTRACT

An analyzer (1) comprises: a detecting section (254) for continuously detecting the capacitance between an electrode (253) provided in a nozzle cleaning tank (252) and a suction nozzle (251b) ; a determining section (45) for determining whether the suction nozzle (251b) is clogged or not based on the time dependency of capacitance detected at the detecting section (254), that is the time dependency of capacitance between the suction nozzle (251b), which is raised out of the nozzle cleaning tank (252) after BF cleaning liquid (Lw) is sucked, and the electrode (253); and a controlling section (41) for stopping the discharge of the BF cleaning liquid from an discharge nozzle (251a) into a reaction tube (10) when it is determined by the determining section (45) that the suction nozzle (251b) is clogged.

### CROSS-REFERENCE TO RELATED APPLICATIONS

This application is a continuation of PCT international application Ser. No. PCT/JP2009/050774 filed on Jan. 20, 2009 which designates the United States, incorporated herein by reference, and which claims the benefit of priority from Japanese Patent Application No. 2008-010854, filed on Jan. 21, 2008, incorporated herein by reference.

### TECHNICAL FIELD

The present invention relates to cleaning equipment and an analyzer including the cleaning equipment, the cleaning equipment including a discharge nozzle for discharging cleaning liquid, and a suction nozzle inserted in a cleaning tank or reaction container together with the discharge nozzle, for sucking cleaning liquid or reaction liquid in the cleaning tank or reaction container.

### BACKGROUND ART

Analyzers are capable of performing an analyzing process for a large number of samples simultaneously as well as analyzing many ingredients promptly with high accuracy, so that the analyzers can be used for testing in various fields, such as immunological testing, biochemical testing and blood transfusion testing. Among these analyzers, an analyzer for immunological testing of a tumor marker and an infectious disease is in general applied with a heterogeneous analysis method for performing BF (Bound-Free) separation to separate a reaction product from an unreacted product by the pouring and sucking of BF cleaning liquid (see Japanese Laid-Open Publication No. 2003-83988, for example) .

### DISCLOSURE OF THE INVENTION

In this case, the analyzer sucks the BF cleaning liquid from a reaction tube through a suction nozzle for sucking the BF cleaning liquid. However, foreign substances may exist in a reaction liquid in the reaction tube, into which the BF cleaning liquid is poured. If the suction nozzle is clogged due to the foreign substances, the BF cleaning liquid may be left in the reaction tube, which causes a problem of BF cleaning liquid overflow from the reaction tube when further BF cleaning liquid is discharged into the reaction tube.

The present invention is intended to solve the defect of the conventional technique described above. The objective of the present invention is to provide cleaning equipment and an analyzer, the cleaning equipment being capable of precisely detecting an occurrence of nozzle clogging and reducing the number of reaction tubes overflowing with liquid to a minimum.

In order to solve the problem and achieve the objective described above, the cleaning equipment according to the present invention includes: a discharge nozzle for discharging cleaning liquid; a suction nozzle inserted in a nozzle cleaning tank or a reaction container together with the discharge nozzle, for sucking cleaning liquid or reaction liquid in the nozzle cleaning tank or the reaction container; and an elevator section for raising and lowering the discharge nozzle and the suction nozzle to insert the discharge nozzle and the suction nozzle in the nozzle cleaning tank or the reaction container, the cleaning equipment further including: a detecting section for continuously detecting capacitance between an electrode provided either inside or in the periphery of the nozzle cleaning tank, and the suction nozzle; a determining section for determining whether or not the suction nozzle is clogged on the basis of the time dependence of a capacitance detected by the detecting section, the time dependence of the capacitance being between the suction nozzle raised out of the nozzle cleaning tank after the suction of the cleaning liquid and the electrode; and a controlling section for stopping the discharge of the cleaning liquid into the reaction container through the discharge nozzle when it is determined by the determining section that the suction nozzle is clogged.

Further, in the cleaning equipment according to the present invention, the determining section determines that the suction nozzle is clogged if an elapsed time from a time when the elevator section starts raising the suction nozzle after the suction of the cleaning liquid to a time when capacitance is reduced to a predetermined capacitance value between the suction nozzle and the electrode, exceeds a predetermined period of time; and determines that the suction nozzle is not clogged if the elapsed time does not exceed the predetermined period of time.

Still further, in the cleaning equipment according to the present invention, the electrode is provided inside a side wall and a bottom wall of the nozzle cleaning tank, or is provided along a surface of the side wall and/or a surface of the bottom wall of the nozzle cleaning tank.

Still further, an analyzer according to the present invention is for stirring and reacting a sample and a reagent, and measuring optical characteristics of a reaction liquid to analyze the reaction liquid, in which the analyzer cleans a suction nozzle, which has sucked cleaning liquid or the reaction liquid, using the cleaning equipment according to the present invention.

The cleaning equipment, and the analyzer including the cleaning equipment, according to the present invention include: a discharge nozzle for discharging cleaning liquid; a suction nozzle inserted in a nozzle cleaning tank or a reaction container together with the discharge nozzle, for sucking cleaning liquid or reaction liquid in the nozzle cleaning tank or the reaction container; and an elevator section for raising and lowering the discharge nozzle and the suction nozzle to insert the discharge nozzle and the suction nozzle in the nozzle cleaning tank or the reaction container, the cleaning equipment further including: a detecting section for continuously detecting capacitance between an electrode provided either inside or in the periphery of the nozzle cleaning tank, and the suction nozzle; a determining section for determining whether or not the suction nozzle is clogged on the basis of the time dependence of a capacitance detected by the detecting section, the time dependence of a capacitance being between the suction nozzle raised out of the nozzle cleaning tank after the suction of the cleaning liquid and the electrode; and a controlling section for stopping the discharge of the cleaning liquid into the reaction container through the discharge nozzle when it is determined by the determining section that the suction nozzle is clogged, thereby achieving the effect of detecting the occurrence of nozzle clogging with certainty and reducing the number of reaction tubes overflowing with liquid to its minimum.

### BRIEF DESCRIPTION OF THE DRAWINGS

FIG. 1 is a schematic view illustrating a structure of an analyzer according to the present embodiment.

FIG. 2 is a diagram describing a structure of a nozzle cleaning tank illustrated in FIG. 1.

FIG. 3 is a diagram describing a raising process of a suction nozzle in a case where the suction nozzle illustrated in FIG. 2 is not clogged.

FIG. 4 is a diagram illustrating a time change in capacitance between the suction nozzle and an electrode illustrated in FIG. 2.

FIG. 5 is a diagram describing a raising process of the suction nozzle in a case where the suction nozzle illustrated in FIG. 2 is clogged.

FIG. 6 is a flowchart illustrating process steps of a clogging occurrence detecting process for the suction nozzle in the analyzer illustrated in FIG. 1.

FIG. 7 is a diagram describing a structure of the nozzle cleaning tank illustrated in FIG. 1.

FIG. 8 is a diagram describing a raising process of a suction nozzle in a case where the suction nozzle illustrated in FIG. 7 is not clogged.

FIG. 9 is a diagram describing another structure of the nozzle cleaning tank illustrated in FIG. 1.

FIG. 10 is a diagram describing still another structure of the nozzle cleaning tank illustrated in FIG. 1.

FIG. 11 is a diagram describing still another structure of the nozzle cleaning tank illustrated in FIG. 1.

1 analyzer

2 measuring mechanism

4 controlling mechanism

10 reaction tube

21 sample transferring section

21a sample container

21b sample rack

22 tip storing section

23 sample dispenser section

24 immunoreaction table

24a outer circumference line

24b intermediate circumference line

24c inner circumference line

25 BF table

251 BF cleaning section

252 nozzle cleaning tank

253 electrode

254 detecting section

255 alternating voltage generating section

251a discharge nozzle

251b suction nozzle

26 first reagent repository

26a first reagent container

27 second repository

27a second reagent container

27b substrate liquid container

28 first reagent dispenser section

29 second reagent dispenser section

30 enzyme reaction table

31 photometer section

32 first reaction tube transferring section

33 second reaction tube transferring section

41 controlling section

43 inputting section

44 analyzing section

45 determining section

46 storing section

47 outputting section

48 displaying section

49 transmitting and receiving section

### BEST MODE FOR CARRYING OUT THE INVENTION

Hereinafter, an embodiment of an analyzer according to the present invention will be described in detail with reference to the accompanying figures. Note that the present invention will not be limited to this embodiment.

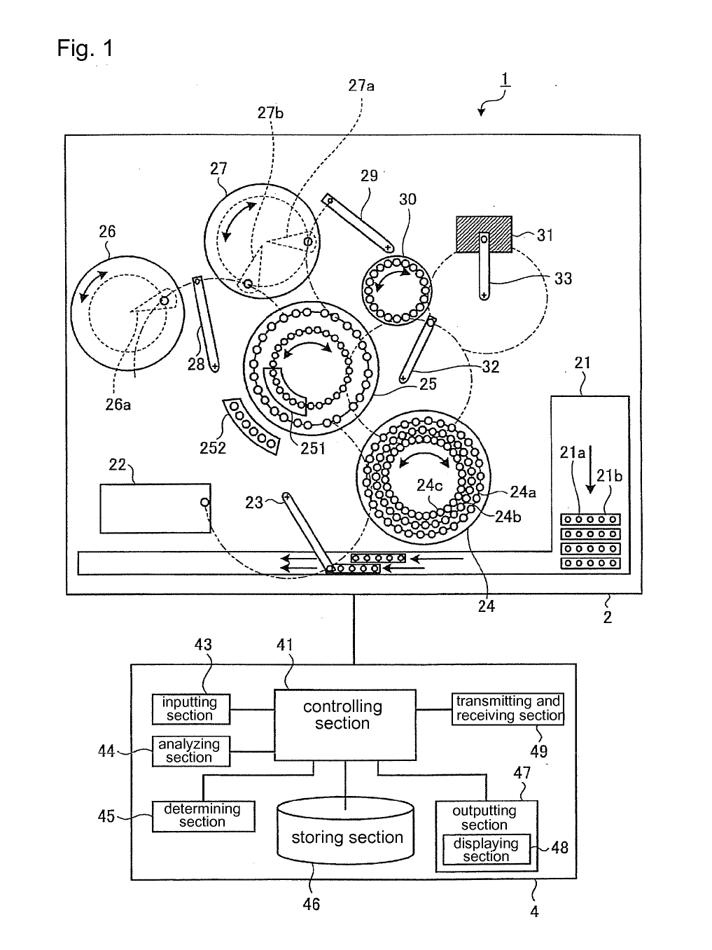

FIG. 1 is a schematic view illustrating a structure of an analyzer according to the present embodiment. As illustrated in FIG. 1, an analyzer 1 according to the present embodiment includes: a measuring mechanism 2 for measuring the amount of luminescence of a luminescent substance due to an action of a reactant between a sample and a reagent; and a controlling mechanism 4 for controlling the overall analyzer 1 including the measuring mechanism 2 and analyzing a measurement result in the measuring mechanism 2. The analyzer 1 automatically performs immunological analysis of a plurality of samples with the cooperation of the two mechanisms.

First, the measuring mechanism 2 will be described. The measuring mechanism 2 generally includes: a sample transferring section 21; a tip storing section 22; a sample dispenser section 23; an immunoreaction table 24; a BF table 25; a first reagent repository 26; a second reagent repository 27; a first reagent dispenser section 28; a second reagent dispenser section 29; an enzyme reaction table 30; a photometer section 31; a first reaction tube transferring section 32 and a second reaction tube transferring section 33. Each of the constitutional parts of the measuring mechanism 2 includes a singular or a plurality of units for performing a predetermined operational process.

The sample transferring section 21 retains a plurality of sample containers 21a, each containing a sample; and includes a plurality of sample racks 21b, each being continuously transferred in the direction of the arrow in FIG. 1. Each sample contained in the sample container 21a may be blood, urine or the like collected from a sample provider.

The tip storing section 22 is provided with a tip case with a plurality of tips disposed therein, and tips are supplied from the tip case. Each of the tips is a disposable sample tip, which is attached to a nozzle tip of the sample dispenser section 23 to prevent carry-over during measuring of infectious disease items and which is exchanged with another one for each dispensed sample.

The sample dispenser section 23 includes an arm, which is attached with a tip for sucking and discharging a sample at the tip portion thereof, and freely performs rising and lowering in a vertical direction as well as rotating with a vertical line passing through a base end section thereof as the central axis. The sample dispenser section 23 sucks a sample in the sample container 21a, which is moved to a predetermined position by the sample transferring section 21, through the tip. The sample dispenser section 23 subsequently turns the arm and dispenses the sample into a reaction tube conveyed to a predetermined position by the BF table 25, where the sample is transferred into the reaction tube on the BF table 25 at a predetermined time.

The immunoreaction table 24 includes a reaction line for reacting a sample with a predetermined reagent corresponding to an analysis item, in each reaction tube disposed thereon. The immunoreaction table 24 is capable of rotating itself freely for each reaction line, with a vertical line passing through the center of the immunoreaction table 24 as an axis of rotation. The immunoreaction table 24 also transfers the reaction tube disposed on the immunoreaction table 24 to a predetermined position at a predetermined time. As illustrated in FIG. 1, the immunoreaction table 24 may be formed with a triple reaction line structure, including an outer circumference line 24a for pretreatment and pre-dilution, an intermediate circumference line 24b for immunoreaction between a sample and a solid-phase carrier reagent, and an inner circumference line 24c for immunoreaction between a sample and a labeled reagent.

The BF table 25 performs a BF cleaning process to perform BF (Bound-Free) separation for separating an unreacted substance in a sample or a reagent by sucking and discharging a predetermined cleaning liquid. The BF table 25 is capable of rotating itself freely for each reaction line, with a vertical line passing through the center of the BF table 25 as an axis of rotation. The BF table 25 also transfers a reaction tube disposed on the BF table 25 to a predetermined position at a predetermined time. The BF table 25 includes: a magnetic collection mechanism for magnetically collecting magnetic particles necessary for the BF separation; a BF cleaning section 251 with a BF cleaning nozzle, the BF cleaning nozzle performing the BF separation by the discharging and sucking of the BF cleaning liquid into and from the reaction tube; and a stirring mechanism for dispersing the magnetically collected magnetic particles.

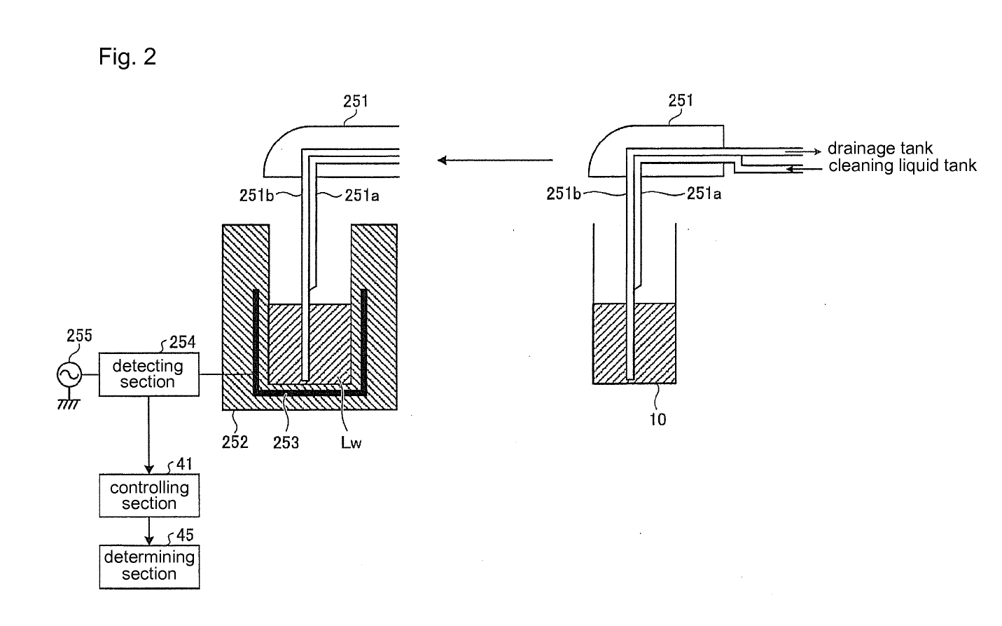

As illustrated in FIG. 2, the BF cleaning section 251 includes a plurality of pairs of a discharge nozzle 251a and a suction nozzle 251b corresponding to the discharge nozzle 251a, as the BF cleaning nozzle. The discharge nozzle 251a discharges the BF cleaning liquid into a reaction tube 10, the BF cleaning liquid being supplied from a cleaning liquid tank (not shown). The suction nozzle 251b sucks the BF cleaning liquid in the reaction tube 10 and drains the sucked BF cleaning liquid to a drainage tank (not shown).

In addition, the BF cleaning section 251 all together performs raising and lowering operation in a vertical direction, and moving operation in a horizontal direction, of the discharge nozzle 251a and the suction nozzle 251b. The discharge nozzle 251a and the suction nozzle 251b are transferred to a nozzle cleaning tank 252, as indicated by the arrow in the figure, every time the BF cleaning process ends in each reaction tube 10, and the suction nozzle 251b is cleaned with BF cleaning liquid Lw discharged from the discharge nozzle 251a. In this case, a controlling section 41 causes the discharge nozzle 251a to discharge the BF cleaning liquid Lw into the nozzle cleaning tank 252 to soak the suction nozzle 251b in the BF cleaning liquid Lw, thereby cleaning the side wall of the suction nozzle 251b. Next, the BF cleaning liquid Lw in the nozzle cleaning tank 252 is sucked and drained by the suction nozzle 251b to clean the inner wall of the suction nozzle 251b. The suction nozzle 251b is made of a metal with excellent conductivity, such as stainless steel, and the lower end of the suction nozzle 251b is disposed below the lower end of the discharge nozzle 251a. In addition, the nozzle cleaning tank 252 is made of an insulating material, such as resin, with a permittivity higher than the atmosphere. Further, each nozzle cleaning tank 252 is provided for each pair of the discharge nozzle 251a and suction nozzle 251b.

The first reagent repository 26 can house a plurality of first reagent containers 26a, each of which contains a first reagent to be dispensed in a reaction tube disposed on the BF table 25. The second repository 27 can house a plurality of second reagent containers 27a, each of which contains a second reagent to be dispensed in a reaction tube disposed on the BF table 25. The first and second repositories 26 and 27 are capable of rotating freely either clockwise or counterclockwise by the driving of a driving mechanism (not shown), so that they can transfer a desired reagent container to a reagent suction position by the first reagent dispenser section 28 or the second reagent dispenser section 29. The first reagent contains magnetic particles, which are insoluble carriers formed by solidifying a reactant specifically binding to an antigen or antibody in a sample of analytic interest. The second reagent contains a labeled substance (e.g. enzyme) specifically binding to an antigen or antibody bound to a magnetic particle. The second repository 27 houses a substrate liquid container 27b, which contains a substrate liquid. The substrate liquid contains a substrate which is luminous by an enzyme reaction with a labeled substance. Further, the second repository 27 rotates either clockwise or counterclockwise to convey a predetermined substrate liquid container 27b to a substrate sucking position by the first reagent dispenser section 28.

The first reagent dispenser section 28 includes an arm, which is attached with a probe for sucking and discharging the first reagent at the tip portion thereof and freely performs rising and lowering in a vertical direction as well as rotating, with a vertical line passing through a base end section thereof as the central axis. The first reagent dispenser section 28 sucks a reagent in the first reagent container 26a, which is moved to a predetermined position by the first reagent repository 26, using a probe, and turns the arm to dispense the reagent into the reaction tube 10, which is conveyed to a first reagent discharging position by the BF table 25. In addition, the first reagent dispenser section 28 sucks the substrate liquid in the substrate liquid container 27b, which is moved to a predetermined position by the second repository 27, using a probe, and the first reagent dispenser section 28 turns the arm to dispense the substrate liquid into the reaction tube 10, which is conveyed to a substrate liquid discharging position by the BF table 25.

Having a structure similar to that of the first reagent dispenser section 28, the second reagent dispenser section 29 sucks a reagent in a second reagent container 27a, which is moved to a predetermined position by the second repository 27, using a probe. The second reagent dispenser section 29 subsequently turns an arm to dispense the reagent into the reaction tube 10 , which is conveyed to a predetermined position by the BF table 25.

The enzyme reaction table 30 is a reaction line for performing an enzyme reaction process for allowing the substrate, which is in the substrate liquid poured in the reaction tube, to be luminous. The photometer section 31 measures luminescence from the substrate contained in the reaction liquid in the reaction tube. The photometer section includes a photomultiplier tube for detecting weak luminescence generated in chemiluminescence, for example, and measures the amount of luminescence using a counting method. In addition, the photometer section 31 includes an optical filter, and calculates true luminescence intensity using a measurement value of luminescence which is reduced by the optical filter in accordance with luminescence intensity.

The first reaction tube transferring section 32 includes an arm, which freely performs rising and lowering in a vertical direction as well as rotating, with a vertical line passing through a base end section thereof as the central axis, and which transfers the liquid-containing reaction tube 10 at a predetermined time to a predetermined position of the immunoreaction table 24, the BF table 25, the enzyme reaction table 30, a reaction tube supplying section (not shown), and a reaction tube discarding section (not shown). Further, the second reaction tube transferring section 33 includes an arm, which freely performs rising and lowering in a vertical direction as well as rotating, with a vertical line passing through a base end section thereof as the central axis, and which transfers the liquid-containing reaction tube 10 at a predetermined time to a predetermined position of the enzyme reaction table 30, the photometer section 31 and the reaction tube discarding section (not shown).

Next, the controlling mechanism 4 will be described. The controlling mechanism 4 includes: a controlling section 41; an inputting section 43; an analyzing section 44; a determining section 45; a storing section 46, an outputting section 47 and a transmitting and receiving section 49. The sections included in the measuring mechanism 2 and controlling mechanism 4 are electrically connected to the controlling section 41. The controlling mechanism 4 is effectuated using one or a plurality of computer systems, and is connected to the measuring mechanism 2. The controlling mechanism 4 controls operational processing of the measuring mechanism 2 and analyzes a measurement result in the measuring mechanism 2, using various programs related to respective processes of the analyzer 1.

The controlling section 41 is constituted of a CPU and the like, which have a controlling function, to control processes and operations of respective elements of the analyzer 1. The controlling section 41 performs predetermined input and output control on information that is input in and output from these elements, and also performs predetermined information processing on the information. The controlling section 41 executes the controlling of the analyzer 1 by reading out programs stored in the storing section 46 from its memory.

The inputting section 43 is constituted of a keyboard for inputting various kinds of information, a mouse for designating a point on a screen of a display, which constitutes the outputting section 47, and the like. The inputting section 43 obtains, from the outside, various pieces of information necessary for the analysis of a sample and instructional information for analysis operations, and the like. The analyzing section 44 performs an analysis process and the like on a sample on the basis of a measurement result obtained from the measuring mechanism 2.

The determining section 45 determines whether or not the suction nozzle 251b is clogged, on the basis of a time dependence of capacitance, the time dependence of capacitance being measured by a later-described detecting section for detecting capacitance continuously between an electrode provided in the nozzle cleaning tank 252 and the suction nozzle 251b, and the time dependence of capacitance being between the suction nozzle 251b raised out of the cleaning tank after the suction of the BF cleaning liquid and the electrode. When the determining section 45 determines that the suction nozzle 251b is clogged, the controlling section 41 stops discharging the BF cleaning liquid from the discharge nozzle 251a into the reaction tube 10.

The storing section 46 is constituted of a hard disk for storing information magnetically, and a memory for loading and electrically storing various programs from the hard disk, the programs being associated with processes of the analyzer 1 in executing the processes. The storing section 46 stores various kinds of information, including an analysis result of a sample. The storing section 46 may include an auxiliary storage capable of reading out information stored in a storage medium, such as a CD-ROM, DVD-ROM, PC card or the like.

The outputting section 47 is constituted of a printer, a speaker or the like, and outputs various pieces of information related to analysis under the control of the controlling section 41. The outputting section 47 includes a displaying section 48, which is constituted of a display or the like. If it is determined by the determining section 45 that the suction nozzle 251b is clogged, the outputting section 47 outputs a warning, under the control of the controlling section 41, to inform the clogging of the suction nozzle 251b. The transmitting and receiving section 49 has a function of an interface for transmitting and receiving information in accordance with a predetermined format, via a communication network (not shown).

In the analyzer for performing immunological testing, a first reagent dispensing process is performed. In the process, the reaction tube 10 is transferred from a reaction tube supplying section, which is not shown in FIG. 1, to a predetermined position of the BF table 25 by the first reaction tube transferring section 32, and a first reagent containing magnetic particles is dispensed from the first reagent dispenser section 28 into the reaction tube 10. Subsequently, a sample dispensing process is performed, in which a sample is dispensed from a sample container 21a, which is transferred to a predetermined position by the sample transferring section 21, to the reaction tube 10 on the BF table 25 by the sample dispenser section 23 attached with a tip supplied from the tip storing section 22.

Next, the sample in the reaction tube 10 is stirred by a stirring mechanism of the BF table 25 and subsequently the reaction tube 10 is transferred to the intermediate circumference line 24b of the immunoreaction table 24 by the first reaction tube transferring section 32. In this case, after the passage of a predetermined reaction time, a reactant is generated, in which an antigen and the magnetic particles are bound to each other in the sample. Subsequently, the reaction tube 10 is transferred to the BF table 25 by the first reaction tube transferring section 32 to perform a first BF cleaning process for removing an unreacted substance inside the reaction tube 10. Next, as a second reagent, a labeled reagent containing a labeled antibody is dispensed from the second reagent dispenser section 29 into the reaction tube 10 after the BF separation to perform a second reagent dispensing process for the stirring by the stirring mechanism. As a result, an immune complex is generated, in which the reactant and labeled antibody are bound to each other.

The reaction tube 10 is next transferred to the inner circumference line 24c in the immunoreaction table 24 by the first reaction tube transferring section 32, and is transferred to the BF table 25 after the passage of a predetermined reaction time. Subsequently, a second BF cleaning process, at a second time cleaning, is performed on the reaction tube 10 to remove an unreacted labeled antibody. Subsequently, a substrate liquid dispensing process is performed, in which substrate liquid containing a substrate is dispensed into the reaction tube 10 to be stirred again. Next, the reaction tube 10 is transferred to the enzyme reaction table 30 by the first reaction tube transferring section 32, and after the passage of a predetermined reaction time necessary for enzyme reaction, the reaction tube 10 is transferred to the photometer section 31 by the second reaction tube transferring section 33. The substrate which has undergone enzyme reaction emits light by an enzyme action of the immune complex. In this state, a measuring process is performed, in which a light L emitted from the substrate is measured by the photometer section 31. The analyzing section 44 subsequently performs an analyzing process for determining the amount of antigens of a detection target on the basis of the amount of light measured.

Next, the nozzle cleaning tank 252 illustrated in FIG. 1 will be described with reference to FIG. 2. As illustrated in FIG. 2, an electrode 253 is provided in the side wall and bottom wall of the nozzle cleaning tank 252, the electrode 253 being made of a conductive material. The electrode 253 is connected to a detecting section 254. The detecting section 254 detects the change in an AC current flowing through the electrode 253, using the conductive suction nozzle 251b as the other electrode, to detect the capacitance between the suction nozzle 251b and the electrode 253, and further outputs an electric signal corresponding to the detected capacitance to the determining section 45 through the controlling section 41. The detecting section 254 detects the capacitance between the suction nozzle 251b and the electrode 253 continuously. As one of the configurations for detecting the change in the capacitance, one end of an alternating voltage generating section 255 may be grounded and the other end thereof may be connected to the electrode 253 with the detecting section 254 interposed therebetween.

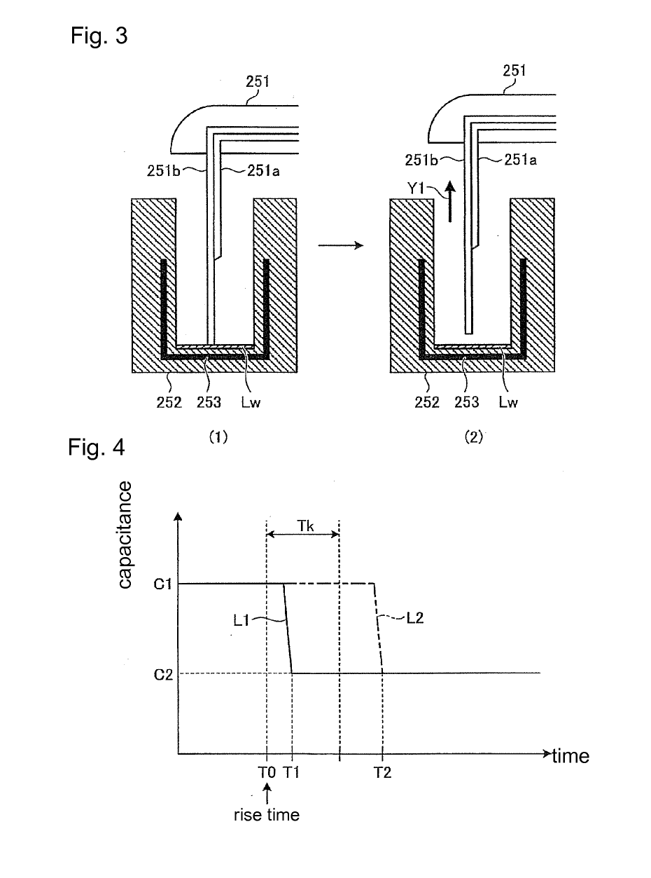

At this stage, in the analyzer 1 according to the present invention, it is determined whether or not the suction nozzle 251b is clogged on the basis of the time dependence of capacitance between the suction nozzle 251b and the electrode 253. The details will be described with reference to FIGS. 3 to 5.

First, a case where the suction nozzle 251b is not clogged will be described. The suction nozzle 251b is not clogged, and therefore, as illustrated in FIG. 3(1), the BF cleaning liquid Lw, which has completed the cleaning of the suction nozzle 251b, is sucked by the suction nozzle 251b and drained out of the nozzle cleaning tank 252. The suction nozzle 251b including a nozzle pressing spring (not shown) to make contact with the bottom wall of the nozzle cleaning tank 252, so that the BF cleaning liquid Lw is drained with certainty after the completion of cleaning the suction nozzle 251b. At this stage, the bottom wall of the nozzle cleaning tank 252 is in a wet condition with the BF cleaning liquid Lw even if the BF cleaning liquid Lw is substantially sucked by the suction nozzle 251b. Consequently, as illustrated in FIG. 3(1), the suction nozzle 251b is in a state where it makes contact with the electrode 253 with the BF cleaning liquid Lw interposed therebetween. By such contacting of the suction nozzle 251b and the electrode 253 with the BF cleaning liquid Lw interposed therebetween, the capacitance between the suction nozzle 251b and the electrode 253 is indicated as a high capacitance C1 prior to a rise time TO of the suction nozzle 251b as illustrated in FIG. 4.

Next, as indicated by an arrow Y1 in FIG. 3(2), when the suction nozzle 251b and discharge nozzle 251a start to be raised by the BF cleaning section 251, the suction nozzle 251b is separated from the BF cleaning liquid Lw wetting the bottom wall, after the compressed nozzle pressing spring (not shown) is returned to its normal state. That is, by the rise of the suction nozzle 251b and discharge nozzle 251a, the suction nozzle 251b is released from contacting with the electrode 253 with the BF cleaning liquid Lw interposed therebetween after a certain period of time. Accordingly, when the suction nozzle 251b is not clogged as illustrated with a curve L1 in FIG. 4, the contact between the suction nozzle 251b and the electrode 253 is released after a certain period of time after the rise time of the suction nozzle 251b. As a result, the capacitance between the suction nozzle 251b and the electrode 253 is changed to a capacitance C2, which is remarkably lower than the capacitance C1 as illustrated in FIG. 4, at a time T1, during which a time necessary for the compressed nozzle pressing spring to return to its normal state elapses after the rise time TO of the suction nozzle 251b.

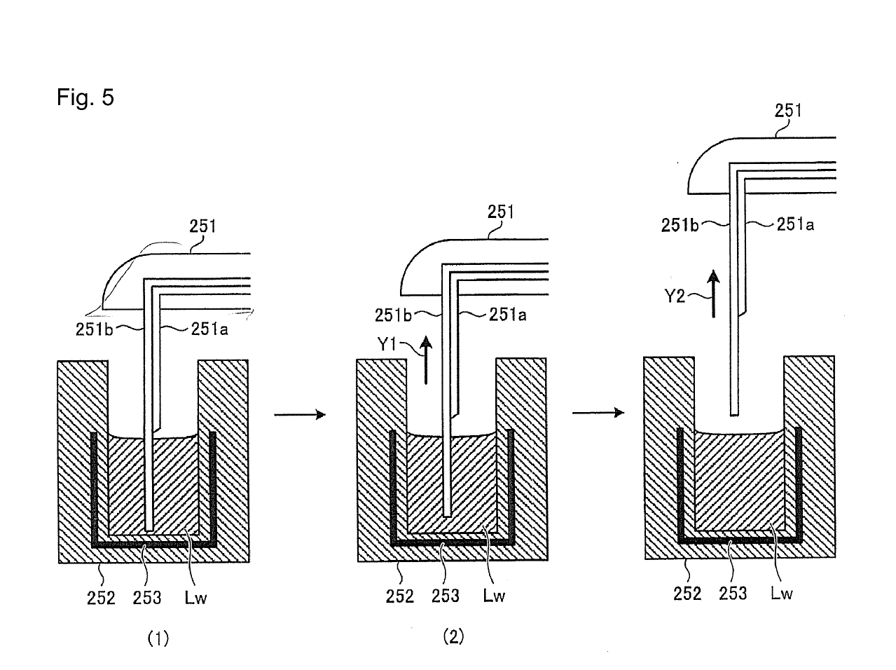

Next, a case where the suction nozzle 251b is clogged will be described. As illustrated in FIG. 5(1), when the suction nozzle 251b is clogged, the BF cleaning liquid Lw is not drained out of the nozzle cleaning tank 252 even after the cleaning of the suction nozzle 251b is completed. As a result, the BF cleaning liquid Lw remains in the nozzle cleaning tank 252. This means that the suction nozzle 251b remains soaked in the BF cleaning liquid Lw even after the suction nozzle 251b has risen to the height at which the contacting with the BF cleaning liquid Lw is drained if there is no clogging, by the start of the rise of the BF cleaning section 251 as indicated by the arrow Y1 in FIG. 5(2).

When the lower end of the suction nozzle 251b has risen to the upper part of the nozzle cleaning tank 252 as indicated by an arrow Y2 in FIG. 5(3), the suction nozzle 251b is finally separated from the BF cleaning liquid Lw.

Therefore, the BF cleaning liquid Lw remains in the nozzle cleaning tank 252 if the suction nozzle 251b is clogged, and the contact is not released between the suction nozzle 251b and the electrode 253 if the lower end of the suction nozzle 251b has not risen to the upper part of the nozzle cleaning tank 252. In such a case, as illustrated with a curve L2 in FIG. 4, the capacitance between the suction nozzle 251b and the electrode 253 remains indicating the high capacitance C1 even after the time T1, during which a time necessary for the compressed nozzle pressing spring to return to its normal state elapses after the rise time TO of the suction nozzle 251b. The capacitance between the suction nozzle 251b and the electrode 253 is finally changed to the capacitance C2 at a time T2, during which the lower end of the suction nozzle 251b rises up to the upper part of the nozzle cleaning tank 252 and the suction nozzle 251b is separated from the BF cleaning liquid Lw.

As described above, in the case where the suction nozzle 251b is clogged, the contacting time is extended between the BF cleaning liquid Lw, which has not been sucked due to the clogging, and the suction nozzle 251b after the rise of the suction nozzle 251b, which results in different time dependence of capacitance between the suction nozzle 251b and the electrode 253 compared to the case where the clogging does not occur. More particularly, as illustrated in FIG. 4, the time between the rise time of the suction nozzle 251b and the time when the capacitance between the suction nozzle 251b and the electrode 253 is reduced to the certain capacitance C2, varies depending on the cases where the suction nozzle 251b is clogged or not.

Owing to this fact, in the analyzer 1, a threshold time Tk is set, which is switchable in accordance with the case where the suction nozzle 251b is clogged and the case where the suction nozzle 251b is not clogged, during the time between the rise time of the suction nozzle 251b and the time when the capacitance between the suction nozzle 251b and the electrode 253 is reduced to the certain capacitance C2. The determining section 45 determines the occurrence of the clogging in the suction nozzle 251b on the basis of whether or not the time between the rise time of the suction nozzle 251b and the time when the capacitance between the suction nozzle 251b and the electrode 253 is reduced to the certain capacitance C2, exceeds the threshold time Tk. Note that the threshold time Tk is set as follows: the time dependence of capacitance is detected in advance between the suction nozzle 251b and the electrode 253 at the rise of the suction nozzle 251b in both of the cases where the suction nozzle 251b is clogged and is not, and the threshold time Tk is set on the basis of its detection result and detection process time difference.

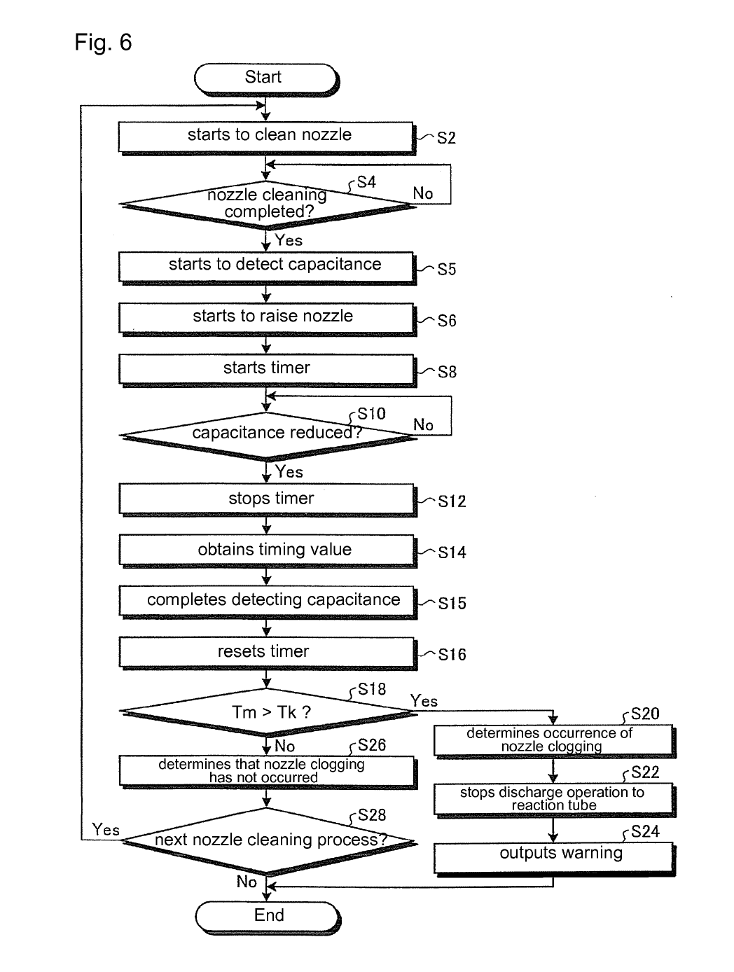

Next, a process for detecting clogging in the suction nozzle 251b in the analyzer 1 will be described with reference to FIG. 6. As illustrated in FIG. 6, the controlling section 41 starts a nozzle cleaning process, where after the completion of the BF cleaning process, the BF cleaning section 251 is caused to move the suction nozzle 251b, which has performed the BF cleaning process, together with the discharge nozzle 251a into the nozzle cleaning tank 252, and the suction nozzle 251b is cleaned (step S2). Subsequently, the controlling section 41 determines whether or not the BF cleaning liquid Lw in the nozzle cleaning tank 252 is completely sucked by the suction nozzle 251b and the nozzle cleaning process is completed (step S4). The controlling section 41 repeats the determining process in the step S4 until it determines that the nozzle cleaning process is completed.

Further, when the controlling section 41 determines that the nozzle cleaning process is completed (step S4: Yes), the controlling section 41 causes the detecting section 254 to start detecting the capacitance between the suction nozzle 251b and the electrode 253 (step S5). Subsequently, the determining section 45 causes the BF cleaning section 251 to start a nozzle rising process for rising the discharge nozzle 251a and suction nozzle 251b so that the discharge nozzle 251a and suction nozzle 251b are transferred out of the nozzle cleaning tank 252 (step S6). The controlling section 41 further causes a timer built in the determining section 45 to start timing at the same time with the rise time of the BF cleaning section 251 (step S8). The capacitance detected by the detecting section 254 between the suction nozzle 251b and the electrode 253 is continuously output to the determining section 45 through the controlling section 41.

In addition, the determining section 45 determines whether or not the capacitance between the suction nozzle 251b and the electrode 253, which is continuously output from the detecting section 254, is reduced to a predetermined capacitance value, such as the C2 (step S10). The determining section 45 repeats the determining process of the step S10 until the capacitance between the suction nozzle 251b and the electrode 253 is reduced to a predetermined capacitance; and when the capacitance between the suction nozzle 251b and the electrode 253 is reduced to the predetermined capacitance (step S10: Yes) the determining section 45 stops the built-in timer (step S12). The determining section 5 further obtains a timing value Tm of this timer (step S14) and temporarily stores the value; and subsequently the controlling section 41 causes the detecting section 254 to complete the detection of the capacitance between the suction nozzle 251b and the electrode 253 (step S15) and returns the timing value of the timer in the determining section 45 to zero for resetting (step S16).

The timing value Tm obtained by the determining section 45 herein corresponds to an elapsed time from a time when the BF cleaning section 251 starts to raise the suction nozzle 251b after the suction of the BF cleaning liquid to a time when the capacitance between the suction nozzle 251b and the electrode 253 is reduced to a predetermined capacitance value. The determining section 45 compares the timing value Tm and the predetermined threshold time Tk to determine whether or not Tm>Tk applies (step S18).

When the Tm>Tk applies, it corresponds to a case where it has taken a long time for the suction nozzle 251b to be separated from the BF cleaning liquid, and it corresponds to a case where the BF cleaning liquid Lw still remains in the nozzle cleaning tank 252 due to the nozzle clogging. Owing to this, when the determining section 45 determines that the Tm>Tk applies (step S18: Yes), it determines that the suction nozzle 251b is clogged (step S20) and outputs the determining result to the controlling section 41. Upon receiving the determining result, the controlling section 41 stops the operation for discharging the BF cleaning liquid to the reaction tube 10 through the discharge nozzle 251a (step S22). More particularly, the controlling section 41 stops the discharging of the BF cleaning liquid through the discharge nozzle 251a to the reaction tube 10 on which the suction nozzle 251b, which is determined to be clogged, performed the BF cleaning process in the BF cleaning process immediately prior. Further, the controlling section 41 causes the outputting section 47 to output a warning for informing that the suction nozzle 251b has been clogged (step S24).

In contrast, when the Tm>Tk does not apply (step S18: No), that is, when the timing value Tm is equal to or below the threshold time Tk, it corresponds to a case where the suction nozzle 251b has been immediately separated from the BF cleaning liquid, and it corresponds to a case where the BF cleaning liquid Lw does not remain in the nozzle cleaning tank 252; in other words, a case where the BF cleaning liquid

Lw is properly drained from the nozzle cleaning tank 252 by the suction nozzle 251b. As such, when the determining section 45 determines that the Tm >Tk does not apply (step S18: No), it determines that the suction nozzle 251b is not clogged (step S26) and outputs the determining result to the controlling section 41. Since the suction nozzle 251b is not clogged and thus can function properly and the BF cleaning process can be continued, it is determined whether or not a next BF cleaning process and/or next nozzle cleaning process is performed (step S28). When the next BF cleaning process and/or next nozzle cleaning process is determined to be performed (step S28: Yes), the suction nozzle 251b and discharge nozzle 251a are caused to perform the BF cleaning process, and subsequently, the step returns to the step S2 to start the nozzle cleaning process. In addition, when the controlling section 41 determines that a next BF cleaning process and/or next nozzle cleaning process is not performed (step S28: No), it completes the process.

In the present embodiment as described above, it is precisely detected as to whether or not the suction nozzle 251b is clogged, by utilizing the fact that, in the case of the clogging in the suction nozzle 251b, the contacting time at the rise of the suction nozzle 251b is extended between the BF cleaning liquid Lw which has not been sucked owing to the clogging and the suction nozzle 251b, and that the time dependence of capacitance varies between the suction nozzle 251b and the electrode 253 compared to the case where the suction nozzle 251b is not clogged, and on the basis of the time dependence of capacitance between the suction nozzle 251b, which is raised out of the nozzle cleaning tank 252 after the suction of the BF cleaning liquid, and the electrode 253. Further, in the present embodiment, when it is determined that the suction nozzle 251b is clogged, the discharge of the BF cleaning liquid by the discharge nozzle 251a is stopped, so that it becomes possible to prevent a further BF cleaning liquid from being discharged into the reaction tube 10, in which the BF cleaning liquid still remains, and it becomes possible to reduce the number of reaction tubes 10 overflowing with the liquid to its minimum.

Further, in the present embodiment, the clogging of the suction nozzle 251b can be detected for each suction nozzle cleaning process in the nozzle cleaning tank 252. Therefore, even if the suction nozzle 251b gets clogged during the BF cleaning process, the clogging can be detected during the nozzle cleaning process following the BF cleaning process, and the discharging of the BF cleaning liquid can be stopped in a next BF cleaning process. As a result, it becomes possible to reduce the possibility of continuing the analyzing process while the suction nozzle 251b is being clogged, to its minimum.

Still further, in the present embodiment, the occurrence of clogging is detected in the suction nozzle 251b in a state where the BF cleaning liquid Lw is involved in the nozzle cleaning tank 252. That is, since the occurrence of clogging is detected in the suction nozzle 251b in a state where the same type of liquid is always involved in the present embodiment, it becomes possible to maintain the accuracy of the detection process stably, compared to a method for detecting the occurrence of clogging in a state where a different liquid is involved every time.

In a conventional manner, a detecting method is proposed, where an electrode is provided in the periphery of a pipe, which connects a suction nozzle and a drainage tank, and the change in capacitance between the electrode and the suction nozzle, that is an impedance change, is detected during the suction of a reaction liquid in a reaction tube in a BF cleaning process, to detect the occurrence of clogging in the suction nozzle. In this detecting method, however, there have been cases where the suction nozzle sucks a reaction liquid containing a substance, such as protein, in the reaction tube, and the protein or the like adheres and is accumulated on an inner wall of a pipe, which is continuously connected to the suction nozzle and is made of an insulation material. Furthermore, if the BF cleaning liquid has conductive properties, the BF cleaning liquid infiltrates into this accumulation, and thus, the impedance of a resistive component is always reduced between the suction nozzle and the electrode in the periphery of the pipe. As a result, it becomes difficult to detect an impedance change resulting from the change in a weak capacitance component. Furthermore, even if the suction nozzle is actually clogged, the change cannot be detected in the impedance resulting from the clogging, and there have been cases where the clogging is not detected in the suction nozzle.

In the present embodiment, on the other hand, even in a case where extraneous matter, such as protein, is accumulated on an inner wall of a pipe, which is made of an insulation material and is continuously connected with the suction nozzle 251b, capacitance is detected between the electrode 253, which is provided not in the periphery of the pipe but in the nozzle cleaning tank 252, and the suction nozzle 251b, which is positioned in a space away from the electrode 253, with liquid, such as BF cleaning liquid Lw, being involved. Accordingly, the detection is not influenced by the accumulation at all. In the present embodiment, therefore, the reduction of capacitance owing to the separation of the suction nozzle 251b from the BF cleaning liquid Lw can be accurately detected, thereby detecting the occurrence of clogging in the suction nozzle 251b with high accuracy.

It is also possible to set the threshold time Tk for each suction nozzle 251b in accordance with the installation height of the suction nozzle 251b. Ina case where a plurality of suction nozzles and discharge nozzles are attached in an elevator mechanism, an error occurs in the installation height among respective suction nozzles 251b owing to the error in the attachment height of the nozzles.

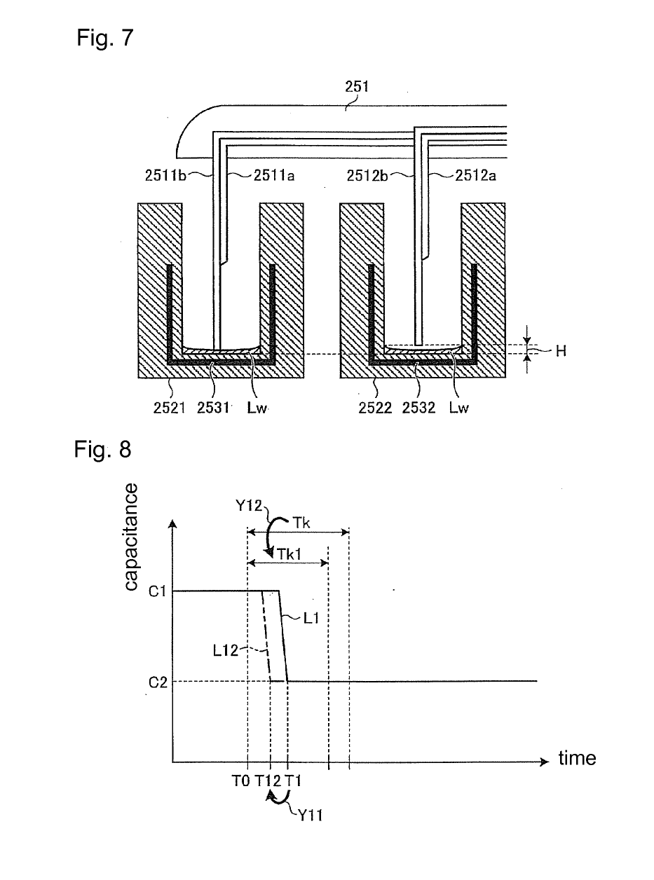

For example, as illustrated in FIG. 7, a comparison will be made between a suction nozzle 2511b with a lower end substantially contacting a bottom wall of a nozzle cleaning tank 2521, and a suction nozzle 2512b with a lower end positioning at a height H from a bottom wall of a nozzle cleaning tank 2522. In this case, since the lower end of the suction nozzle 2512b is positioned higher than the lower end of the suction nozzle 2511b, the suction nozzle 2512b is separated from BF nozzle cleaning liquid Lw earlier than the suction nozzle 2511b does. Accordingly, as illustrated by a curve L12 in FIG. 8, the capacitance is reduced between the suction nozzle 2512b and an electrode 2532 to a predetermined capacitance value C2 at a time T12 as indicated by an arrow Y11, which is earlier than a time T1 when the capacitance is reduced between the suction nozzle 2511b and an electrode 2531, as illustrated by a curve L1. Thus, a threshold time for detecting clogged suction of the suction nozzle 2512b is set to a time Tk1, which is shorter than a threshold time Tk corresponding to the suction nozzle 2511b, as indicated by an arrow Y12 in FIG. 8. In FIG. 7, a discharge nozzle 2511a is a discharge nozzle paired with the suction nozzle 2511b, and a discharge nozzle 2512a is a discharge nozzle paired with the suction nozzle 2512b.

In both cases where the suction nozzle 2512b is clogged and the suction nozzle 2512b is not clogged, time dependence of capacitance is detected in advance between the suction nozzle 2512b and the electrode 2532 at the rise of the suction nozzle 2512b, and the threshold time Tk1 is set based on the detection result and the time necessary for a compressed nozzle pressing spring (not shown) to return to its normal state. In addition, the relationship is obtained in advance between each height of the lower ends of the suction nozzles and each threshold time set on the basis of each reduction time reducing to a predetermined capacitance value C2, and the relationship is stored in advance in the analyzer 1. In this case, the determining section 45 may make a determination of the clogging in the suction nozzle by obtaining the height of the lower end of the suction nozzle 2512b as a clogging detection subject, on the basis of information being input from the inputting section 43 or the like, and by using a threshold time corresponding to the obtained height of the lower end of the suction nozzle 2512b from the stored relationship, as a threshold time for the suction nozzle 2512b.

In the present embodiment as described above, each threshold time Tk is set in accordance with separation timing from the BF cleaning liquid Lw, which is different for each suction nozzle, so that it becomes possible to detect more accurately whether or not each suction nozzle is clogged.

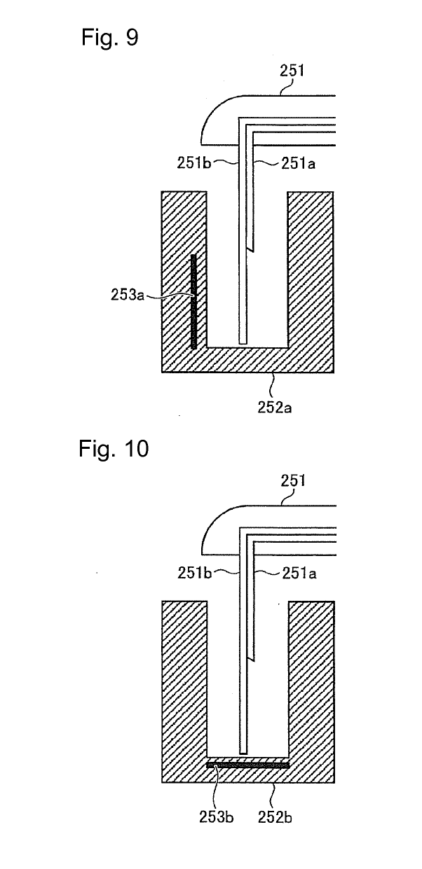

Further, in the present embodiment, the case has been described as an example where the electrode 253 is provided in a cup shape inside the side wall and bottom wall of the nozzle cleaning tank 252 to enlarge the electrode area. However, it is sufficient to detect the change in capacitance between the suction nozzle 251b and the electrode. Thus, as illustrated in FIG. 9, an electrode 253a may be provided only in a side wall of a nozzle cleaning tank 252a; or as illustrated in FIG. 10, an electrode 253b maybe provided only in a bottom wall of a nozzle cleaning tank 252b.

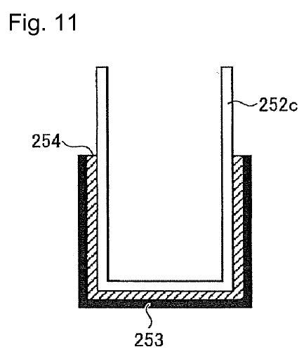

Still further, in the present embodiment, the case has been described as an example where the electrode 253 is provided inside the nozzle cleaning tank 252. However, it is sufficient to detect the change in capacitance between the suction nozzle 251b and the electrode 253. Thus, as illustrated in FIG. 11, the electrode 253 may be provided along surfaces of a side wall and a bottom wall of a nozzle cleaning tank 252c. In this case, it is necessary to set permittivity between the nozzle cleaning tank 252c and the electrode 253 higher than permittivity in the atmosphere in order to detect the capacitance between the suction nozzle 251b and the electrode 253 with certainty. Thus, as illustrated in FIG. 11, a silicon resin 254 with high permittivity fills between the nozzle cleaning tank 252c and the electrode 253 so as not to form an air space. In this case, it is possible to fill between the nozzle cleaning tank 252c and the electrode 253 with certainty and ease by using a fluidity resin, which solidifies over time.

Still further, in the present embodiment, the case has been described as an example with an analyzer which uses a substrate, which is a luminous substance, as a labeled substance. However, without the limitation to this, various cases can be applied to an analyzer for performing a BF cleaning process, such as a case with a fluorescent substance as a labeled substance, a case with a radioactive isotope, and a case with a spin reagent as a labeled substance. In addition, the same can be applied to an analyzer including a suction nozzle that sucks and discharges cleaning liquid in a reaction container.

In addition, the analyzer 1 described in the above embodiment can be effectuated by executing a prepared program in a computer system. The computer system reads out and executes the program stored in a predetermined recording medium to effectuate process operations of the analyzer. Herein, the predetermined recording medium includes, not only a “portable physical medium”, such as a flexible disk (FD), a CD-ROM, an MO disk, a DVD disk, a magneto-optical disk and an IC card, but also every possible recording medium for recording a program which is readable by a computer system, including a “communication medium” for storing a program for a short period of time in transmitting the program, such as a hard disk drive (HDD) which can be provided either inside or outside the computer system. In addition, the computer system obtains and executes a program from a management server and other computer systems connected via a network line to effectuate the process operations of the analyzer.

### INDUSTRIAL APPLICABILITY

As described above, the cleaning equipment and analyzer according to the present invention are useful for precisely detecting occurrence of nozzle clogging and reducing the number of reaction containers overflowing with liquid to a minimum, and more particularly, they are suitable for an automatic analyzer used for immunological analysis including blood and body fluids.

1. Cleaning equipment comprising: a discharge nozzle for discharging cleaning liquid; a suction nozzle inserted in a nozzle cleaning tank or a reaction container together with the discharge nozzle, for sucking cleaning liquid or reaction liquid in the nozzle cleaning tank or the reaction container; and an elevator section for raising and lowering the discharge nozzle and the suction nozzle to insert the discharge nozzle and the suction nozzle in the nozzle cleaning tank or the reaction container,
the cleaning equipment further comprising:
a detecting section for continuously detecting capacitance between an electrode provided either inside or in the periphery of the nozzle cleaning tank, and the suction nozzle;
a determining section for determining whether or not the suction nozzle is clogged on the basis of time dependence of capacitance detected by the detecting section, the time dependence of capacitance being of between the suction nozzle raised out of the nozzle cleaning tank after the suction of the cleaning liquid and the electrode; and
a controlling section for stopping the discharge of the cleaning liquid into the reaction container through the discharge nozzle when it is determined by the determining section that the suction nozzle is clogged.

2. The cleaning equipment according to claim 1, wherein the determining section determines that the suction nozzle is clogged if an elapsed time from a time when the elevator section starts raising the suction nozzle after the suction of the cleaning liquid to a time when capacitance is reduced to a predetermined capacitance value between the suction nozzle and the electrode, exceeds a predetermined period of time;
and determines that the suction nozzle is not clogged if the elapsed time does not exceed the predetermined period of time.

3. The cleaning equipment according to claim 1, wherein the electrode is provided inside a side wall and a bottom wall of the nozzle cleaning tank, or is provided along a surface of the side wall and/or a surface of the bottom wall of the nozzle cleaning tank.

4. The cleaning equipment according to claim 2, wherein the electrode is provided inside a side wall and a bottom wall of the nozzle cleaning tank, or is provided along a surface of the side wall and/or a surface of the bottom wall of the nozzle cleaning tank.

5. An analyzer for stirring and reacting a sample and a reagent, and measuring optical characteristics of a reaction liquid to analyze the reaction liquid, wherein the analyzer cleans a suction nozzle, which has sucked cleaning liquid or the reaction liquid, using the cleaning equipment according to claim 1.

6. An analyzer for stirring and reacting a sample and a reagent, and measuring optical characteristics of a reaction liquid to analyze the reaction liquid, wherein the analyzer cleans a suction nozzle, which has sucked cleaning liquid or the reaction liquid, using the cleaning equipment according to claim 2.

7. An analyzer for stirring and reacting a sample and a reagent, and measuring optical characteristics of a reaction liquid to analyze the reaction liquid, wherein the analyzer cleans a suction nozzle, which has sucked cleaning liquid or the reaction liquid, using the cleaning equipment according to claim 3.

8. An analyzer for stirring and reacting a sample and a reagent, and measuring optical characteristics of a reaction liquid to analyze the reaction liquid, wherein the analyzer cleans a suction nozzle, which has sucked cleaning liquid or the reaction liquid, using the cleaning equipment according to claim 4.
